(19) United States
(12) Patent Application Publication
(10) Pub. No.: US 2012/0160328 A1
(43) Pub. Date: Jun. 28, 2012

(54) HYDRAULIC SWIVEL

(76) Inventors: REED VIVATSON, Temple, TX (US); MARK BERGSTROM, Harker Heights, TX (US); ROBERT DEVONSHIRE, Denver, PA (US)

(21) Appl. No.: 13/335,784

(22) Filed: Dec. 22, 2011

Related U.S. Application Data
(60) Provisional application No. 61/426,410, filed on Dec. 22, 2010.

(51) Int. Cl. F16K 11/02; F16L 27/00

(52) U.S. Cl. 137/1; 137/625.42; 285/272

(57) ABSTRACT

A hydraulic swivel has a case defining a substantially cylindrical interior and a first access port defined in a side thereof, the first access port providing a path for fluid communication between an interior and an exterior of the case. A spool occupies the interior of the case, the spool and the case together defining a first circumferential channel such that the access port is in fluid communication with the channel regardless of the rotational relationship between the case and the spool, and wherein the spool defines a first interior passageway, the first interior passageway having a port connecting to the first circumferential channel. An actuator occupies at least a portion of the first interior channel selectively blocking and enabling fluid communication between the first circumferential channel and the first interior passageway and therefore selectively blocking and enabling fluid communication between the access port and the first interior passageway.

### CROSS REFERENCE TO RELATED APPLICATIONS

This application claims the priority of U.S. Provisional Patent Application No. 61/426,410, entitled “HYDRAULIC SWIVEL,” filed Dec. 22, 2010, the contents of which are hereby incorporated by reference.

### FIELD OF THE INVENTION

This disclosure relates to hydraulic systems in general and, more specifically, to rotatable hydraulic connections.

### BACKGROUND OF THE INVENTION

Hydraulic systems are ubiquitous in the modern age. Nearly every machine in which a linear actuation or force is needed or can be used to produce a desired end can be constructed with hydraulics. Hydraulic motors can be used to move equipment. Hydraulic actuators can be used to control connected mechanical systems. Additionally, hydraulic pumps can easily be driven from power take off (PTO) devices that are commonly built into industrial transmissions.

Although hydraulic systems provide versatility and utility, sometimes the configuration a vehicle or machinery employing the hydraulic system creates issues with connecting the appropriate hydraulic lines and circuits. This is particularly so where the vehicle articulates or swivels in order to do its job. Hydraulic hoses can only be twisted or stressed a certain amount before they will break. Lengthening the hoses to accommodate a large degree of rotation can place slack hose in danger of being damaged. Such damage not only leads to costly repairs, but can also be dangerous due to the high pressures and temperatures of hydraulic fluid.

What is needed is a device and method that addresses the above, and related, issues.

### SUMMARY OF THE INVENTION

The invention of the present disclosure, in one aspect thereof comprises a hydraulic swivel that has a case defining a substantially cylindrical interior and having a first access port defined in a side thereof, the first access port providing a path for fluid communication between an interior and an exterior of the case. The swivel has a spool occupying at least a portion of the cylindrical interior of the case, the spool and the case together defining a first circumferential channel inside the case such that the access port is in fluid communication with the first circumferential channel regardless of the rotational relationship between the case and the spool, and wherein the spool defines a first interior passageway, the first interior passageway having a port connecting to the first circumferential channel. A first actuator occupies at least a portion of the first interior channel and selectively controls fluid communication between the first circumferential channel and the first interior passageway. In some embodiments, the swivel implements a two port, two position hydraulic control valve with the access port and the second interior passageway providing the two ports of the control valve. In some embodiments the swivel implements a pressure controlling valve, a flow controlling valve, a load controlling valve, or a directional control valve. Some embodiments comprise a hydraulic valve attached in a fixed relationship to the outside of the case.

In some embodiments the swivel also includes a second circumferential channel defined by the case and the spool, the second circumferential channel having a port to the first interior channel. Fluid communication may be selectively enabled by the actuator between the first circumferential channel and the first interior channel and between the second circumferential channel and the first interior channel.

In some embodiments, the swivel includes second and third circumferential channels defined by the case and the spool, and a second and third interior channel defined by the spool and having a port to the second and third circumferential channels, respectively. The first interior channel has a port to the second and third circumferential channels. Fluid communication is enabled by the actuator between the first and third circumferential channels when fluid communication between the first and second circumferential channels is blocked, and fluid communication between the first and third circumferential channels is blocked whenever fluid communication between the first and second channels is enabled. In some embodiments, this swivel may implement a three-port, two-position control valve in a hydraulic circuit where the access port and the second and third interior channels provide the three ports of the control valve.

In some embodiments, the case is substantially smooth on its interior and the spool has at least one groove cut thereinto to define the first circumferential channel. In other embodiments, the spool is substantially smooth on an outer surface thereof and the case has at least one groove cut into its interior to define the first circumferential channel. The actuators may comprise a hydraulic solenoid. The hydraulic solenoid is controlled from an end of the spool that rotates independently of the case. In other embodiments, the actuator comprises a plunger that may be actuated from an end of the spool that rotates independently of the case.

The invention of the present disclosure, in another aspect thereof, comprises a device having a case in a cooperatively fitted relationship with an interior spool such that the spool may freely rotate within the case. An access port is defined in the case and provides for fluid communication between an exterior and an interior of the case. First, second, and third channels are defined between the case and spool such that the access port is in fluid communication with the first channel regardless of the rotation of the spool with respect to the case. A first interior pathway is defined in the spool and has a fluid connection with the first, second, and third channels. A second interior pathway is defined in the spool and has a fluid connection with the second channel. A third interior pathway is defined in the spool and has a fluid connection with the third channel. The device has a selective actuator within the first channel that selectively allows fluid communication between the access port and the second interior pathway and third interior pathway, respectively, by selectively blocking fluid communication between the first interior passageway and the second and third channel, respectively. In some embodiments, the device is configured as a three port, two position hydraulic control valve in a hydraulic circuit, with the access port and the second and third interior pathway providing the three ports of the control valve.

In some embodiments, the actuator comprises and electronically actuated hydraulic solenoid. In other embodiments, the actuator may be a plunger assembly. In some embodiments, the case is substantially smooth on the interior thereof and a plurality of grooves are cut into the spool to at least partially define the first, second, and third channels. In other embodiments, the spool is substantially smooth on an exterior surface thereof and a plurality of grooves are cut into the interior of the case to at least partially define the first, second, and third channels.

The invention of the present disclosure, in another aspect thereof, comprises a method including providing cylindrical case with open ends and an access port in a side thereof, and providing a cylindrical spool sized to fit at least partially into the cylinder and having first, second, and third channels cut longitudinally thereinto and accessible from at least one end thereof. The method includes defining first, second, and third circumferential channels between the cylinder and the spool such that the access port is in fluid communication with the first channel regardless of the degree of rotation between the case and the spool. The method also includes creating three respective ports in the spool connecting the first longitudinal channel to the first circumferential channel, the second circumferential channel, and the third circumferential channel, creating a port in the spool between the second longitudinal channel and the second circumferential channel, and creating a port in the spool between the third longitudinal channel and the third circumferential channel. A selective actuator is provided situated at least partially in the first longitudinal channel that operates to selective block any connection between the first circumferential channel and the second circumferential channel and between the first circumferential channel and the third circumferential channel.

In some embodiments, the method includes constructing a hydraulic circuit using the access port and the second and third longitudinal channels as three ports of a three port, two position hydraulic control valve, and using the actuator to control the valve. Defining first, second, and third circumferential channels further may comprise cutting channels into an exterior surface of the spool. In other embodiments, defining first, second, and third circumferential channels further comprises cutting channels into the interior of the case.

### BRIEF DESCRIPTION OF THE DRAWINGS

FIG. 1 is a perspective view of one embodiment of a hydraulic swivel according to aspects of the present disclosure.

FIG. 2 is top view of the swivel of FIG. 1.

FIG. 3 is a bottom view of the swivel of FIG. 2.

FIG. 4 is a side cutaway view taken along the line AA of FIG. 2.

FIG. 5 is a side cutaway view taken along the line BB of FIG. 2.

FIG. 6 is a side cutaway view taken along the line CC of FIG. 2

FIG. 7 is an end cutaway view of the device of FIG. 1 taken along the line ZZ.

FIG. 8 is a side cutaway view of another embodiment of a hydraulic swivel according to aspects of the present disclosure.

FIG. 9 is a circuit diagram of a circuit that may be implemented by various embodiments of the present disclosure.

### DETAILED DESCRIPTION OF THE PREFERRED EMBODIMENTS

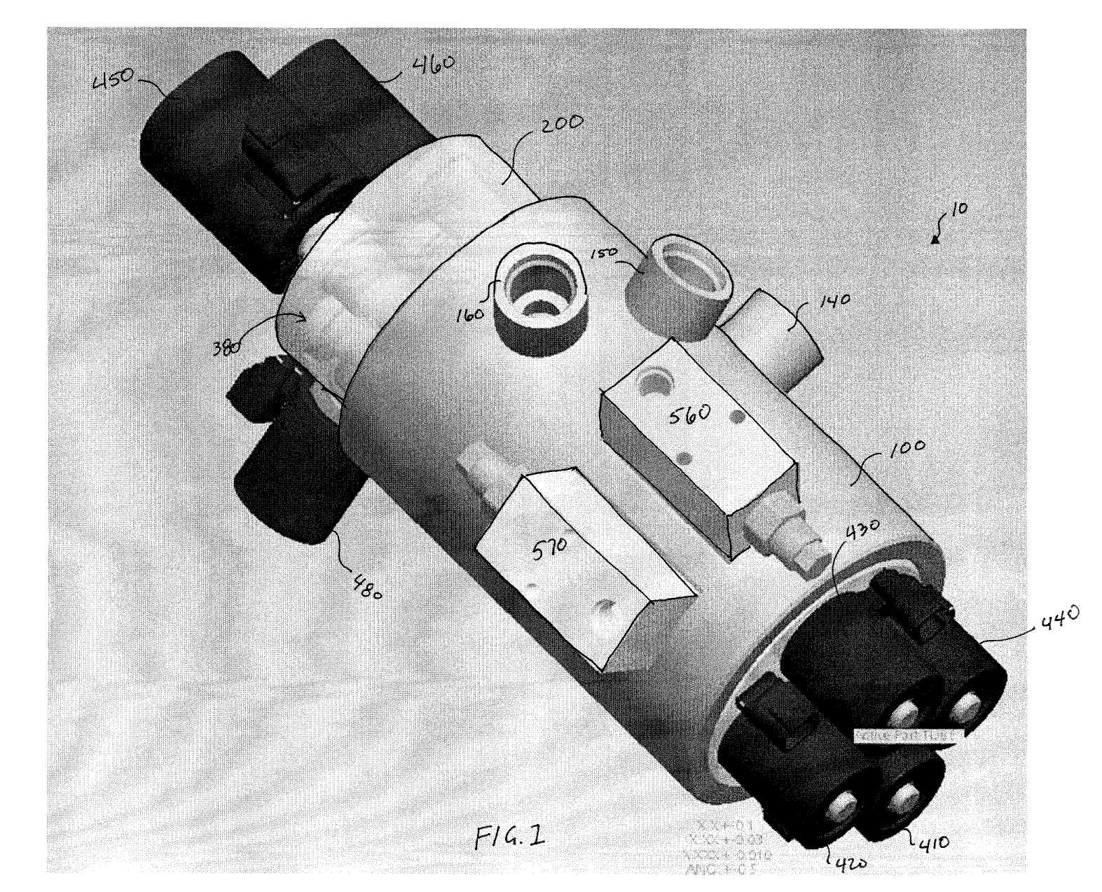

Referring now to FIG. 1, a perspective view of one embodiment of a hydraulic swivel according to aspects of the present disclosure as shown. One function provided by the hydraulic swivel 10 is to pass hydraulic connections unimpeded through a swiveling joint. An additional function of the hydraulic swivel 10 is to provide a functioning hydraulic circuit within the swivel. In the present embodiment, a substantially cylindrical case 100 contains a substantially cylindrical spool 200. The case and the spool are arranged in a relationship to one another such that the case 100 and spool 200 may swivel or rotate up to 360° or more with respect to each other.

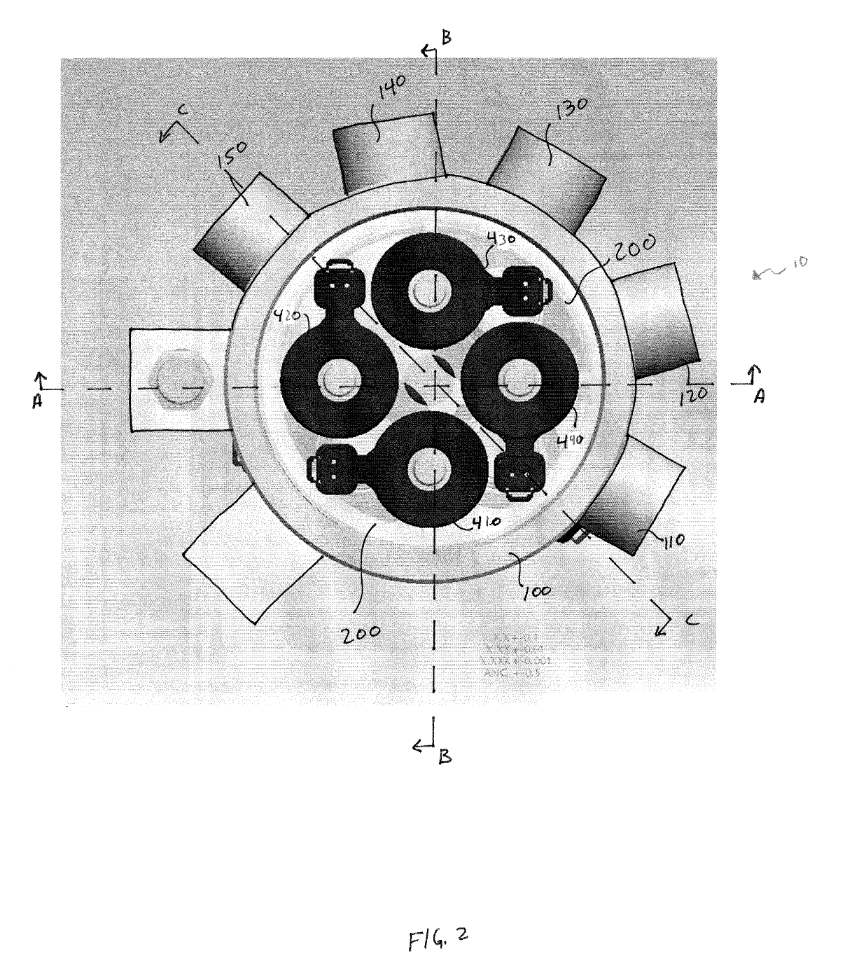

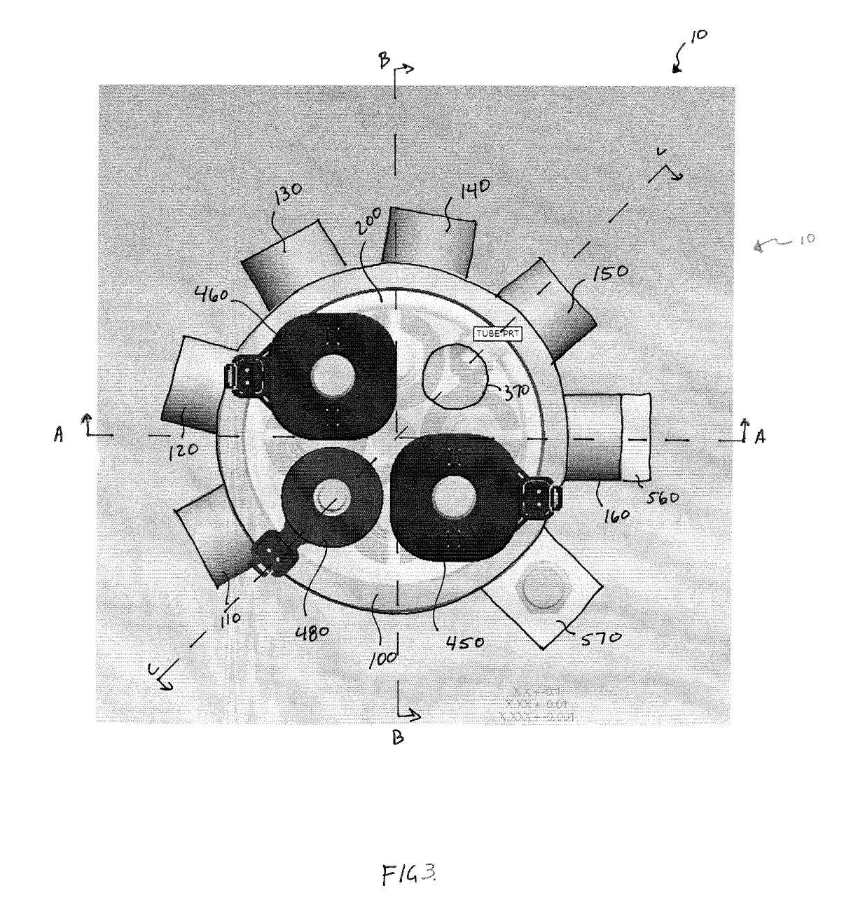

Referring now also to FIGS. 2 and 3, which are bottom and top views, respectively, of the swivel 10, additional exterior componentry will be described. The present embodiment provides a number of hydraulic access ports 110, 120, 130, 140, 150, and 160 arranged at various radial and longitudinal locations on the case 100. The hydraulic access ports 110 through 160 provide fluid communication between the exterior and interior of the case 100. In the present embodiment, in order to supply hydraulic pressure into the swivel 10, a high-pressure input 380 is provided, as can be seen in FIG. 1. In FIG. 3, the high-pressure input is occluded by a hydraulic solenoid 480. A low-pressure return channel 370 may also be provided in the spool 200. In the present embodiment, additional hydraulic access ports hydraulic valves 560, 570 are provided externally on the case 100, and may provide for additional functionality on the case itself.

In addition to a high-pressure input solenoid 480, actuators are provided that are accessible externally to the cylinder 10 that change the hydraulic circuit inside the cylinder electronically. In the present embodiment, four actuators can be seen in FIG. 2 on the upper end of the cylinder 10. Two additional actuators 450 and 460 can be seen on the bottom end of the cylinder end in FIG. 3.

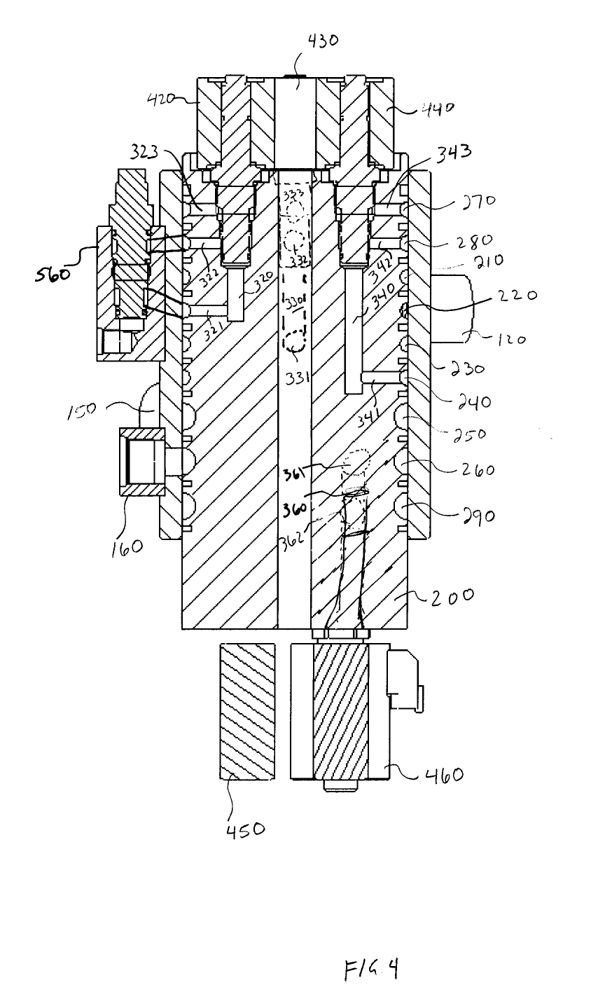

Referring now also to FIG. 4, a cutaway view of the cylinder 10 is shown as taken along line AA in FIG. 2. In the present embodiment, the spool 200 defines a number of channels on the exterior thereof. These channels may be circumferential and circumscribe the spool 200 laterally. In the present embodiment, circumferential channels 210, 220, 230, and 240 correspond to the hydraulic access ports 110, 120, 130, and 140, respectively. Circumferential channels 250 and 260 correspond to hydraulic access ports 150 and 160, respectively. It will be appreciated that in the configuration shown in the various views of the present disclosure, that regardless of the degree of rotation between the case 100 and spool 200, that the respective hydraulic access port will always be in fluid communication with its respective circumferential channel.

The present embodiment also provides for a high-pressure circumferential channel 270 and a low-pressure circumferential channel 280. A second low-pressure circumferential channel 290 is provided near the bottom of the device 10. As will be more apparent from views described more fully below, these high and low-pressure circumferential channels will be selectively connected to the various functional channels 210, 220, 230, 240, 250, and 260, to implement various hydraulic circuitry and functionality. From the present viewpoint of FIG. 4, it can be seen that an actuator, here a solenoid 420, inserts into an interior channel 320 defined in the spool 200. The channel 320 provides a port 321 connecting to circumferential channel 220. The interior channel 320 also connects to the low-pressure circumferential channel 280 via port 322. The interior channel 320 connects to the high-pressure channel 270 by port 323. The actuators of the present disclosure may be commercially available electronically controlled hydraulic solenoids and operative to block or allow access between various ports. Other actuator types are within the scope of this disclosure including, but not limited to a pressure controlling valve, a flow controlling valve, a load controlling valve, or a directional control valve. Mechanically, these may comprise spools, plungers, stoppers, gates, seals, and/or other mechanical implements.

In this case, the actuator 420 blocks or allows access between ports 321 and 322, or between the ports 321 and 323. In this manner, the circumferential channel 220 will have a fluid connection to either the low-pressure return channel 322 or the high-pressure input channel 323. In this way, a device connected to the swivel 10 via the hydraulic port 120 will receive either high or low pressure, depending upon the activation state of the solenoid 420. Additionally, due to the design of the swivel 10, the hydraulic access port 120 will receive the appropriate high or low pressure regardless of amount of rotation between the case 100 and the spool 200.

The actuator 440 operates in much the same way as the actuator 420. The actuator 440 is inserted into an interior longitudinal channel 340 that connects to circumferential channel 240 via port 341. The interior channel 340 also connects to the low-pressure circumferential channel 280 via port 342 and to the high-pressure circumferential channel 270 via the port 343. The actuator 440 is electronically activated and will allow access between the port 341 and 342 or between the port 341 and 343. Thus the circumferential channel 240 will be in fluid communication with the low-pressure circumferential channel 280 or the high-pressure circumferential channel 270. As with all of the hydraulic access ports of the present disclosure, full rotation is allowed between the case 100 and spool 200 while maintaining the appropriate connection.

In the present view, a portion of the actuator 430 can be seen inserted into the interior channel 330, shown in dotted line. The interior channel 330 connects to the circumferential channel 230 via port 331. As before, a port 332 and 333 are provided for connecting to the low-pressure circumferential channel 280 and 270, respectively. As before, the actuator 430 provides selective access between the port 331 and 332, or between the port 331 and 333. Thus, high or low pressure may be provided to hydraulic access port 130.

Shown in dotted line is interior channel 360 into which actuator 460 is inserted. Here it can be seen that the circumferential channel 260 may be connected to the low-pressure circumferential channel 290 or to channel 260 via ports 361 and 362, respectively. Not shown in this view is an internal connection between the interior channel 360 and another high-pressure interior channel within the spool 200. The interior channel 360, being connected to an interior high-pressure channel, the circumferential low-pressure channel 290 and the circumferential channel 260 allows the actuator 460 to selectively connect the channel 260 to either a high or low hydraulic pressure. The hydraulic access port 160 is always in fluid connection with the circumferential channel 260. Therefore, the solenoid 460 controls the hydraulic connection to the hydraulic access port at 160.

It can also be appreciated from the present view, that the circumferential channels may be accessed by more than one hydraulic access port. For example, the valve 560 is connected to both the circumferential channel 280 and the circumferential channel 220. As previously described, the actuator 420 can selectively connect the circumferential channel 220 to high or low pressure. The additional valve 560 allows for additional hydraulic control to be provided that on the outside of the case 100. In one embodiment, the valve 560 implements a load balancing function.

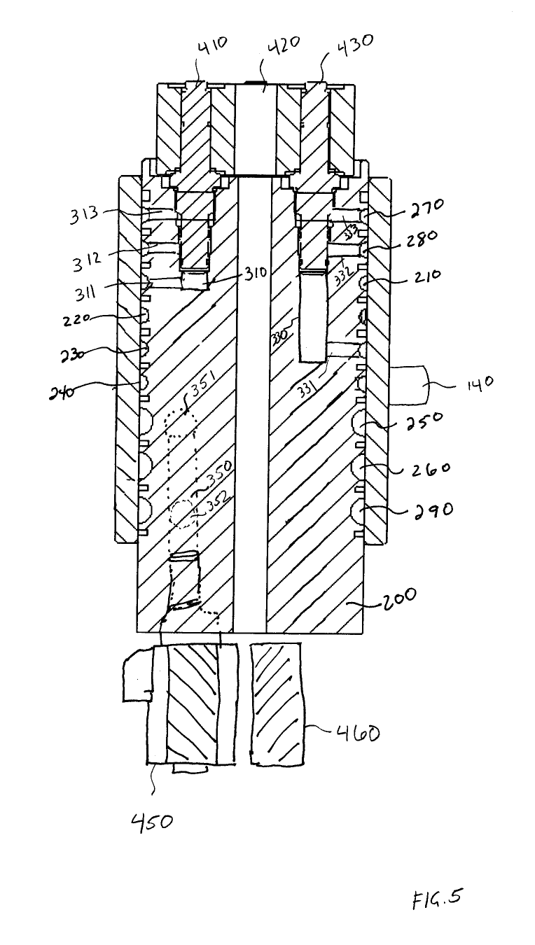

Referring now also to FIG. 5, a side cutaway view of the swivel 10 is seen as taken along the line BB of FIG. 2. Here actuator 410 can be seen seated in interior channel 310 which connects to circumferential channel 210, low-pressure circumferential channel 280, and high-pressure circumferential channel 270 via ports 311, 312, and 313, respectively. The actuator 410 functions in the same manner as the previously described actuators in allowing fluid access to the port 311 and 312 or between port 311 and 313. In this manner, the hydraulic pressure to circumferential port 210 can be selectively electronically controlled by the actuator 410. Hydraulic access port 110 is in continuous fluid communication with the circumferential channel 210. Shown in dotted line is interior channel 350 connecting to circumferential channel 250 via port 351 and to low-pressure circumferential channel 290 via port 352. The actuator 450 provides selective access for the circumferential channel 250 to low-pressure circumferential channel 290 or to an interiorly connected high-pressure channel not shown.

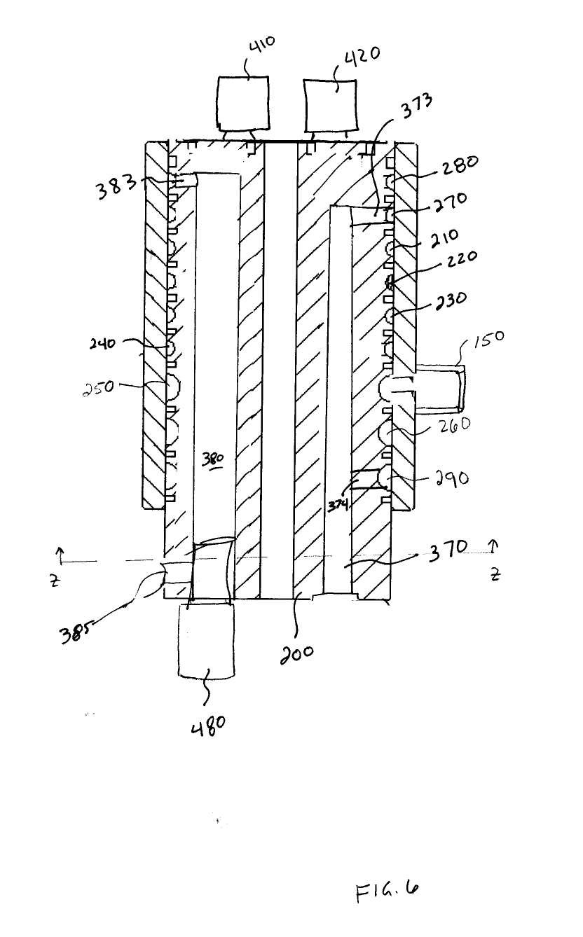

Referring now to FIG. 6, a side cutaway view of the swivel 10 is shown as taken along the line CC of FIG. 2. An interior channel 370 can be seen that is cut longitudinally into the spool 200 and runs from the bottom of the spool to proximate the low-pressure circumferential channel 270. The channel 370 and the channel 270 are connected via port 373 in the present embodiment. The channel 370 also connects to low-pressure circumferential channel 290 via port 374. In the present embodiment, the function of the low-pressure channel 370 is to provide a low hydraulic pressure or a return line to the circumferential channels 270 and 290. As previously described, the circumferential channels 210, 220, 230, 240, 250, and 260 may be selectively connected to either the low-pressure channel 270 or the low-pressure circumferential channel 290. And this way, the various ports may be selectively connected to a low hydraulic pressure. An interior channel 380 is provided in the spool 200 for providing high hydraulic pressure. The channel 380 connects to the high-pressure circumferential channel 280 via port 383. As previously described, the various ports may be selectively connected to the high-pressure circumferential channel 280 and therefore to the high-pressure interior channel 380. In the present embodiment, an actuator 480 is provided for selectively enabling or disabling the high-pressure hydraulic channel 380. In the present embodiment, a connection into the channel 380 is provided via port 385. It may be noted that in the view of FIG. 1, the location of the port 385 and the solenoid 480 are reversed correspond to that of FIG. 6.

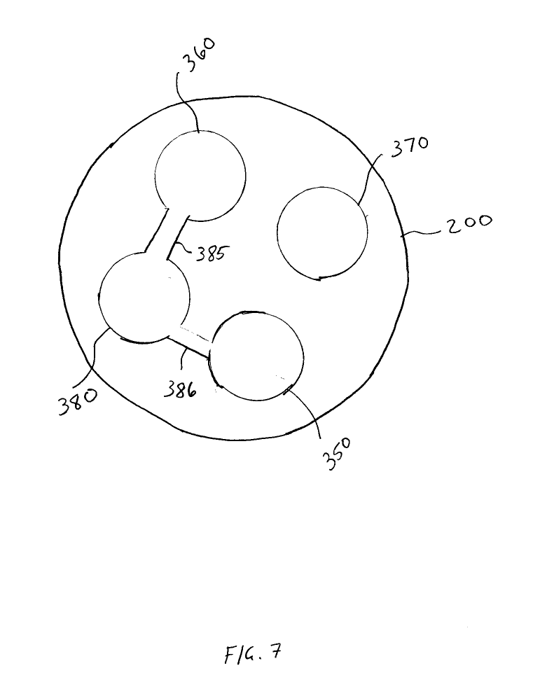

Referring now to FIG. 7, an end cutaway view of the swivel 10 taken along the line ZZ of FIG. 6 is shown. Here the interior channels 350 and 360 are shown fluidly coupled to high-pressure channel 380 via ports 386 and 385, respectively. The location of the internal ports 385, 386 between the channel 360 and 380, and 350 and 380, allows fluid communication to be selectively controlled by actuators 450 and 460, respectively.

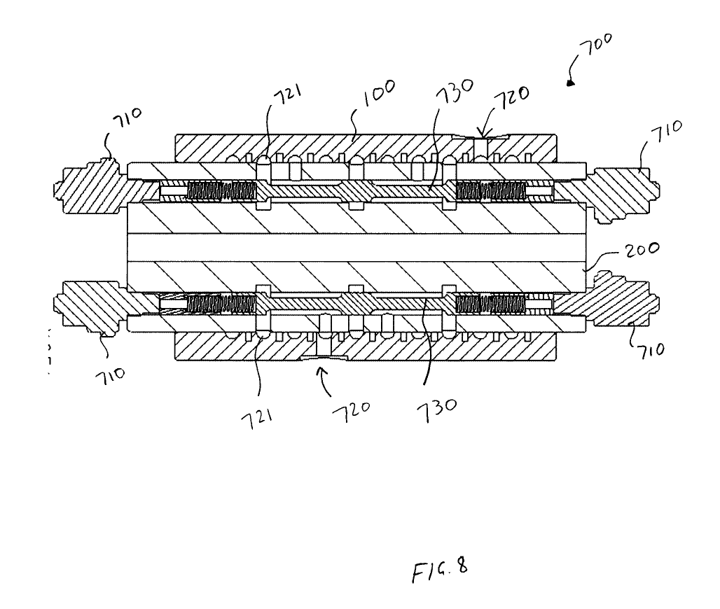

Referring now to FIG. 8, another embodiment of hydraulic swivel 700 according to aspects of the present disclosure is shown. The view of FIG. 8 is that of a side cutaway view. In this embodiment a case 100 once again provided with an internal spool 200. The case 100 and spool 200 are able to freely rotate with respect to one another. High and low-pressure interior channels (not shown) may also be provided in the spool 200. It will be noted that the in the present embodiment, the exterior surface of the spool 200 is substantially smooth while the interior surface of the case 100 has a number of circumferential channels 721 cut therein. In the present embodiment, rather than controlling access between the various circumferential channels using a network of interior channels and solenoids, a plunger 730 is provided that is moved longitudinally via actuator 710. The plunger 730 may be sliding or rotating or motive in some other way. Hydraulic access ports 720 are provided to certain of the circumferential channels 721 to provide an external connection to the case 100. As before, by selective interconnection of the various circumferential channels, the pressure seen at the various circumferential channels 721 and access ports 720 may be controlled from within the spool 200. In one embodiment, the device of FIG. 8 implements a 4-way, three position hydraulic valve. In such an embodiment the plunger moves to expose various ports to high or low pressure on demand.

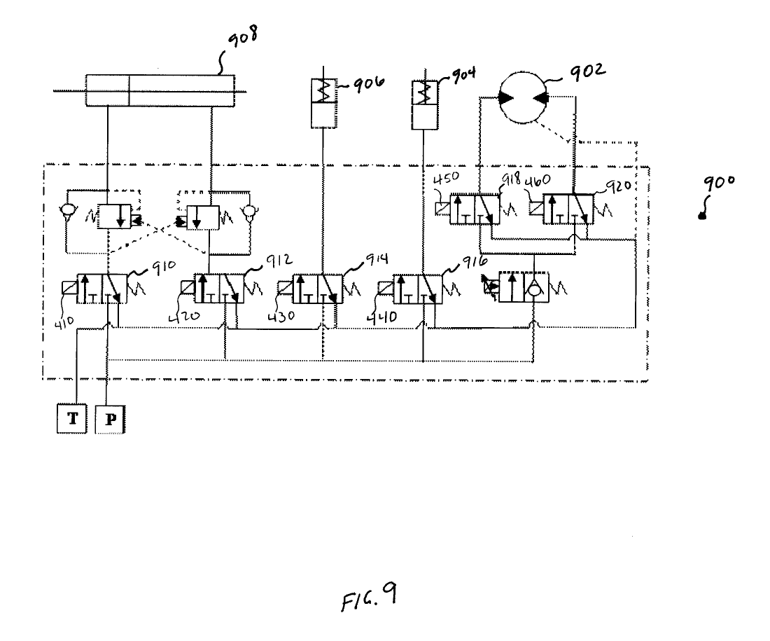

Referring now to FIG. 9, one example of a hydraulic circuit 900 that may be implemented within one or more embodiments of the hydraulic swivels of the present disclosure is shown. In the present embodiment, the circuit 900 provides hydraulic power to a drive motor 902, as well as actuators 904 and 906. As another example, a steering cylinder 908 is also controlled and powered by the circuit 900.

In the present embodiment, a plurality of three port, two position hydraulic control valves 910, 912, 914, and 916 are provided. The actuators 410, 420, 430, and 440, and the associated hydraulic channels they control replicate the functionality of three port, two position hydraulic control valve within the hydraulic swivels previously described. Therefore, in the present circuit, the high-pressure line P may be connected to the high-pressure channel 380 as shown in FIG. 6, and the output of the switch 910 can be connected to hydraulic access port 110. Thus, the actuator 410 will replicate the functionality of the switch 910 within the hydraulic swivel 10 previously described. Actuator 420, by controlling hydraulic access port 120 can replicate the functionality of the switch 912. Switches 914 and 916 can be connected in a similar manner. By electronically activating the various solenoids, used as actuators, the functionality as shown in FIG. 9 can be realized. As shown, the various embodiments of the hydraulic swivel of the present disclosure could also be used to control a drive motor 902. Here, the output of hydraulic switches 918, 920 could be connected to outputs 250 and 260, respectively. The switches 918 and 920 would then be controlled by actuators 450 and 460.

It will be appreciated that FIG. 9 is only one of a multitude of ways in which the hydraulic swivels of the present disclosure could be employed. It is also understood that a hydraulic swivel constructed according to the present disclosure would not necessarily have the same number of hydraulic access ports nor the same internal circuit as shown. The embodiments described are meant only to serve as examples of the concepts of the present disclosure. It will also be appreciated that the case 100 and spool 200 will feature various seals and retainers, as needed, in order to function within specification. The components may be constructed by casting or machining. It will be appreciated that, although the functionality provided within the swivels is complex, the components can be machined with relatively straight forward cutting equipment and other tools.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A hydraulic swivel comprising:
a case defining a substantially cylindrical interior and having a first access port defined in a side thereof, the first access port providing a path for fluid communication between an interior and an exterior of the case;
a spool occupying at least a portion of the cylindrical interior of the case, the spool and the case together defining a first circumferential channel inside the case such that the access port is in fluid communication with the first circumferential channel regardless of the rotational relationship between the case and the spool, and wherein the spool defines a first interior passageway, the first interior passageway having a port connecting to the first circumferential channel; and
a first actuator occupying at least a portion of the first interior channel and selectively controlling fluid communication between the first circumferential channel and the first interior passageway.

2. The hydraulic swivel of claim 1, wherein the swivel implements a two port, two position hydraulic control valve with the access port and the second interior passageway provide the two ports of the control valve.

3. The swivel of claim 1, wherein the swivel implements a pressure controlling valve.

4. The swivel of claim 1, wherein the swivel implements a flow controlling valve.

5. The swivel of claim 1, wherein the swivel implements a load controlling valve.

6. The swivel of claim 1, wherein the swivel implements a directional control valve.

7. The swivel of claim 1, further comprising a hydraulic valve attached in a fixed relationship to the outside of the case.

7. The swivel of claim 1, further comprising:
a second circumferential channel defined by the case and the spool, the second circumferential channel having a port to the first interior channel; and
wherein fluid communication is selectively enabled by the actuator between the first circumferential channel and the first interior channel and between the second circumferential channel and the first interior channel.

8. The hydraulic swivel of claim 1, further comprising:
a second and third circumferential channel defined by the case and the spool; and
a second and third interior channel defined by the spool and having a port to the second and third circumferential channels, respectively;
wherein the first interior channel has a port to the second and third circumferential channels; and
wherein fluid communication is enabled by the actuator between the first and third circumferential channels when fluid communication between the first and second circumferential channels is blocked, and fluid communication between the first and third circumferential channels is blocked whenever fluid communication between the first and second channels is enabled.

9. The hydraulic swivel of claim 8, wherein the swivel implements a three-port, two-position control valve in a hydraulic circuit where the access port and the second and third interior channels provide the three ports of the control valve.

10. The hydraulic swivel of claim 1, wherein the case is substantially smooth on its interior and the spool has at least one groove cut thereinto to define the first circumferential channel.

12. The hydraulic swivel of claim 1, wherein the spool is substantially smooth on an outer surface thereof and the case has at least one groove cut into its interior to define the first circumferential channel.

13. The hydraulic swivel of claim 1, wherein the actuator comprises a hydraulic solenoid.

14. The hydraulic swivel of claim 13, wherein the hydraulic solenoid is controlled from an end of the spool that rotates independently of the case.

15. The hydraulic swivel of claim 1, wherein the actuator comprises a plunger.

16. The hydraulic swivel of claim 15, wherein the plunger is actuated from an end of the spool that rotates independently of the case.

17. A device comprising:
a case in a cooperatively fitted relationship with an interior spool such that the spool may freely rotate within the case;
an access port defined in the case and providing for fluid communication between an exterior and an interior of the case;
first, second, and third channels defined between the case and spool such that the access port is in fluid communication with the first channel regardless of the rotation of the spool with respect to the case;
a first interior pathway defined in the spool and having a fluid connection with the first, second, and third channels;
a second interior pathway defined in the spool and having a fluid connection with the second channel;
a third interior pathway defined in the spool and having a fluid connection with the third channel;
a selective actuator within the first channel that selectively allows fluid communication between the access port and the second interior pathway and third interior pathway, respectively, by selectively blocking fluid communication between the first interior passageway and the second and third channel, respectively.

18. The device of claim 17, wherein the device is configured as a three port, two position hydraulic control valve in a hydraulic circuit, with the access port and the second and third interior pathway providing the three ports of the control valve.

19. The device of claim 17, wherein the actuator comprises and electronically actuated hydraulic solenoid.

20. The device of claim 17, wherein the actuator comprises a plunger assembly.

21. The device of claim 17, wherein the case is substantially smooth on the interior thereof and a plurality of grooves are cut into the spool to at least partially define the first, second, and third channels.

22. The device of claim 17, wherein the spool is substantially smooth on an exterior surface thereof and a plurality of grooves are cut into the interior of the case to at least partially define the first, second, and third channels.

23. A method comprising:
providing cylindrical case with open ends and an access port in a side thereof;
providing a cylindrical spool sized to fit at least partially into the cylinder and having first, second, and third channels cut longitudinally thereinto and accessible from at least one end thereof;
defining first, second, and third circumferential channels between the cylinder and the spool such that the access port is in fluid communication with the first channel regardless of the degree of rotation between the case and the spool;
creating three respective ports in the spool connecting the first longitudinal channel to the first circumferential channel, the second circumferential channel, and the third circumferential channel;
creating a port in the spool between the second longitudinal channel and the second circumferential channel;
creating a port in the spool between the third longitudinal channel and the third circumferential channel;
providing a selective actuator situated at least partially in the first longitudinal channel that operates to selective block any connection between the first circumferential channel and the second circumferential channel and between the first circumferential channel and the third circumferential channel.

24. The method of claim 23, further comprising constructing a hydraulic circuit using the access port and the second and third longitudinal channels as three ports of a three port, two position hydraulic control valve, and using the actuator to control the valve.

25. The method of claim 23, wherein defining first, second, and third circumferential channels further comprises cutting channels into an exterior surface of the spool.

26. The method of claim 23, wherein defining first, second, and third circumferential channels further comprises cutting channels into the interior of the case.
